(19) United States
(12) Patent Application Publication
(10) Pub. No.: US 2007/0139967 A1
(43) Pub. Date: Jun. 21, 2007

(54) Light guide plate with recessed light output surface and backlight module using the same

(75) Inventor: Hsiang-En Peng, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/638,868

(22) Filed: Dec. 14, 2006

(30) Foreign Application Priority Data
Dec. 16, 2005 (TW) 94144812

(51) Int. Cl. F21V 7/04

(52) U.S. Cl. 362/617

(57) ABSTRACT

An exemplary backlight module (120) includes a plurality of optical films (140, 150); a light guide plate (160) having a light output surface (161), the light output surface defines a recessed (165) receiving the optical films; a light source (170) disposed adjacent to a side of the light guide plate; and a frame (190) containing the light source and the light guide plate. With this configuration, the recessed can firmly fix the optical films in the light guide plate. Therefore the backlight module having the optical films and the light guide plate can be mechanically stable and operate properly.

### FIELD OF THE INVENTION

The present invention relates to light guide plates typically used for backlight modules, and especially to a light guide plate structured for fixing optical films therein.

### BACKGROUND

Liquid crystal displays are commonly used as display devices for compact electronic apparatuses, because they not only provide good quality images with little power but also are very thin. The liquid crystal in a liquid crystal display does not emit any light itself. The liquid crystal has to be lighted by a light source so as to clearly and sharply display text and images. Thus, a backlight module is generally needed for a liquid crystal display.

FIG. 8 is a schematic, exploded, isometric view of a conventional liquid crystal display. The liquid crystal display 10 includes a liquid crystal display panel 11, and a backlight module 12 disposed under the liquid crystal display panel 11.

The backlight module 12 includes a light shielding tape 13, a prism film 14, a diffusion film 15, a light guide plate 16, a reflective plate 18, and a frame 19, arranged from top to bottom in substantially that order. The backlight module 12 further includes a plurality of light emitting diodes 17 disposed adjacent to a side of the light guide plate 16. The light shielding tape 13 is adhered to edges of the prism film 14 for shielding light beams thereat. Light beams emitted by the light emitting diodes 17 enter the light guide plate 16, then transmit to the diffusion film 15 and the prism film 14, and finally illuminate the liquid crystal display panel 11.

The prism film 14, the diffusion film 15, and the light guide plate 16 each have corresponding peripheral protrusions 141, 151 and 161, which are received in corresponding grooves 191 of the plastic frame 17. Thereby, these optical films 14, 15 are retained in the frame 19. However, the protrusions 141, 151 and 161 are not necessarily snugly received in the grooves 191. The optical films 14, 15 and the light guide plate 16 are liable to shift in the frame 19 if the liquid crystal display 10 is subjected to vibration or shock during use or transportation. The backlight module 10 may become loose and unstable, and this may impair the performance of the backlight module 10.

Accordingly, what is needed is a light guide plate and a backlight module that can overcome the above-described deficiencies.

### SUMMARY

An exemplary light guide plate includes a light output surface, the light output surface defines a recessed for receiving optical films.

An exemplary backlight module includes a plurality of optical films; a light guide plate having a light output surface, the light output surface defines a recessed receiving the optical films; a light source disposed adjacent to a side of the light guide plate; and a frame containing the light source and the light guide plate.

Other advantages and novel features will become apparent from the following detailed description of preferred embodiments when taken in conjunction with the accompanying drawings. In the drawings, all the views are schematic.

### BRIEF DESCRIPTION OF THE DRAWINGS

FIG. 1 is an isometric view of a light guide plate according to a first embodiment of the present invention.

FIG. 2 is an exploded, isometric view of a liquid crystal display equipped with the light guide plate of FIG. 1.

FIG. 3 is an isometric view of a light guide plate according to a second embodiment of the present invention.

FIG. 4 is an isometric view of a light guide plate according to a third embodiment of the present invention.

FIG. 5 is an isometric view of a light guide plate according to a fourth embodiment of the present invention.

FIG. 6 is an isometric view of a light guide plate according to a fifth embodiment of the present invention.

FIG. 7 is an isometric view of a light guide plate according to a sixth embodiment of the present invention.

FIG. 8 is an exploded, isometric view of a conventional liquid crystal display.

### DETAILED DESCRIPTION OF PREFERRED EMBODIMENTS

Reference will now be made to the drawings to describe the preferred embodiments in detail.

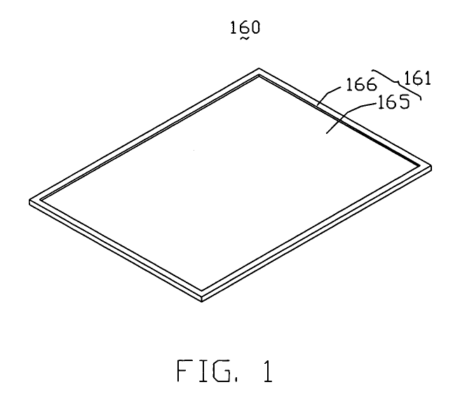

FIG. 1 is a schematic, isometric view of a light guide plate 160 according to a first embodiment of the present invention. The light guide plate 160 is a rectangular solid sheet, and includes a light output surface 161. The light output surface 161 includes a recessed 165, and a plurality of flanges 166 surrounding the recessed 165. In the illustrated embodiment, there are four flanges 166, which are joined end-to-end to cooperatively form a four-sided closed structure. The flanges 166 are an integral part of the light guide plate 160. In particular, the light guide plate 160 may be formed by an injection molding process. The recessed 165 is used for containing one or more optical films, such as a prism film, a diffusion film, or the like. The flanges 166 are used for firmly fixing the optical films in the recessed 165.

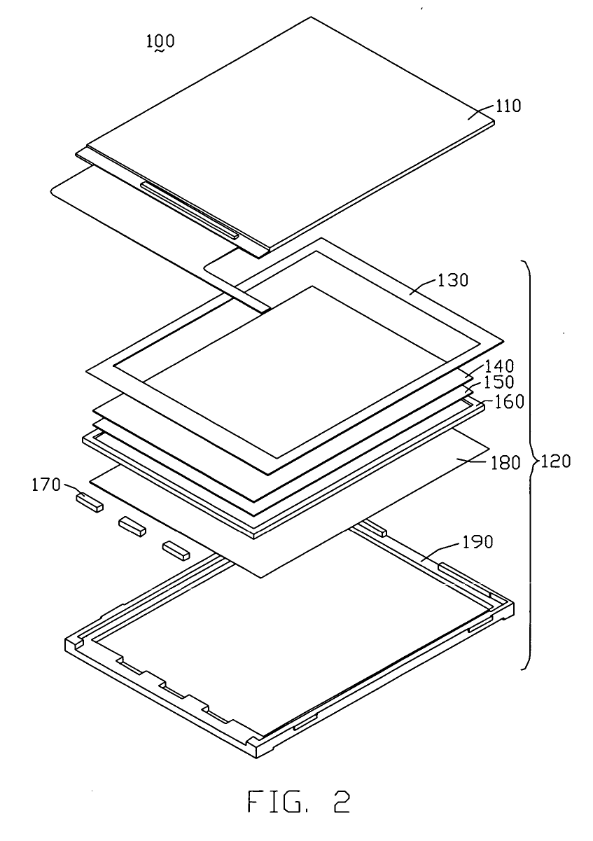

Referring to FIG. 2, this is a schematic, exploded, isometric view of a liquid crystal display employing the light guide plate 160. The liquid crystal display 100 includes a liquid crystal display panel 110 and a backlight module 120. The backlight module 120 includes a light shielding tape 130, a prism film 140, a diffusion film 150, the light guide plate 160, a reflective plate 180, and a frame 190, arranged substantially in that order from top to bottom. Each of the prism film 140 and the diffusion film 150 has a size corresponding to that of the recessed 165 of the light guide plate 160.

In assembly, the light shielding tape 130 is adhered to edges of the prism film 140 for shielding light beams thereat. Then the prism film 140 and the diffusion film 150 are directly disposed in the recessed 165 of the light guide plate 160. The flanges 166 firmly fix the optical films 140, 150 in the recessed 165. The liquid crystal display panel 110, the light guide plate 160 with the optical films 140, 150, and the reflective plate 180 are received in the frame 190. The backlight module 120 further includes a plurality of light emitting diodes 170 disposed adjacent to a side of the light guide plate 160.

In operation, light beams emitted by the light emitting diodes 170 enter the light guide plate 160, then transmit to the diffusion film 150 and the prism film 140, and finally illuminate the liquid crystal display panel 110.

With this configuration, the recessed 165 and the flanges 166 of the light guide plate 160 can firmly fix the optical films 140, 150 in the light output surface 161 of the light guide plate 160. Therefore the backlight module 120 having the optical films 140, 150 and the light guide plate 160 can be mechanically stable and operate properly.

Referring to FIG. 3, this is a schematic, isometric view of a light guide plate according to a second embodiment of the present invention. The light guide plate 260 has a structure similar to that of the light guide plate 160. However, one of flanges 266 of a light output surface 261 of the light guide plate 260 includes a notch 267 defined adjacent to the recessed 265. An optical film (not shown) that is received in the recessed 265 includes a protrusion. When the optical film is received in the recessed 265, the protrusion is received in the notch 267 correspondingly.

The notch 267 and the protrusion are configured to enable a user to accurately position the optical film in the recessed 265 of the light guide plate 260. In particular, if the optical film can properly function only if it is positioned in one predefined orientation relative to the light guide plate 260, the notch 267 and the protrusion ensure that the optical film cannot be wrongly positioned.

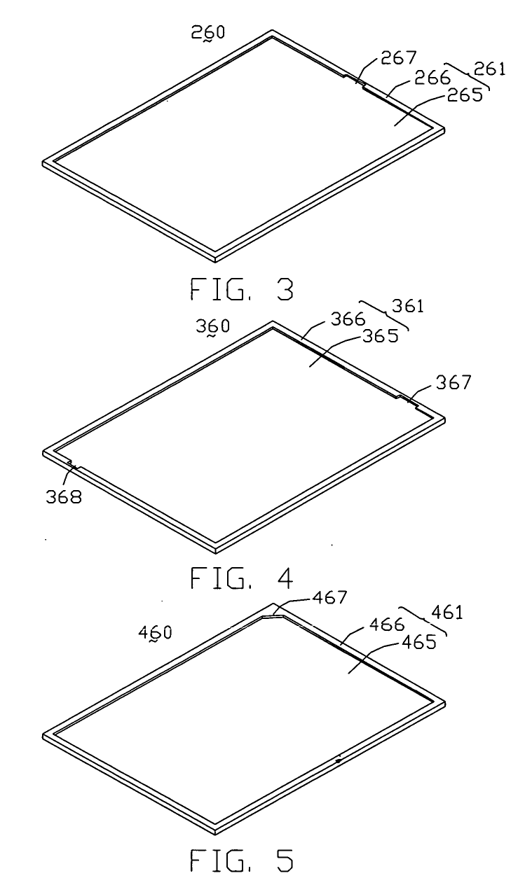

Referring to FIG. 4, this is a schematic, isometric view of a light guide plate according to a third embodiment of the present invention. The light guide plate 360 has a structure similar to that of the light guide plate 160. However, two notches 367, 368 are defined in two opposite flanges 366 respectively. The notches 367, 368 are diagonally opposite each other, and are adjacent to a recessed 365 of a light output surface 361 of the light guide plate 360. Preferably, the notches 367, 368 have different sizes from each other. An optical film (not shown) that is received in the recessed 365 includes two protrusions. When the optical film is received in the recessed 365, the protrusions are received in the notches 367, 368 correspondingly. In alternative embodiments, the notches 367, 368 can be positioned elsewhere in any one or more of four flanges 366. In other alternative embodiments, there can be three or more notches 367, 368.

Referring to FIG. 5, this is a schematic, isometric view of a light guide plate according to a fourth embodiment of the present invention. The light guide plate 460 has a structure similar to that of the light guide plate 160. However, a connecting corner 467 is provided between two adjacent flanges 466. The connecting corner 467 has an oblique edge adjacent to a recessed 465 of the light guide plate 460. An optical film (not shown) that is received in the recessed 465 includes an oblique cutout portion at a corner thereof. The cutout portion matches with the connecting corner 467 of the light guide plate 460.

The connecting corner 467 and the cutout portion are configured to enable a user to accurately position the optical film in the recessed 465 of the light guide plate 460. In particular, if the optical film can properly function only if it is positioned in one predefined orientation relative to the light guide plate 460, the connecting corner 467 and the cutout portion ensure that the optical film cannot be wrongly positioned.

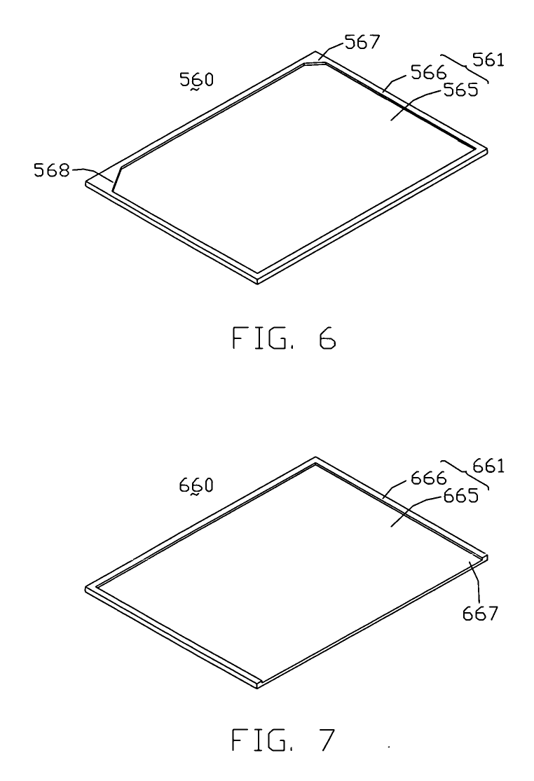

Referring to FIG. 6, this is a schematic, isometric view of a light guide plate according to a fifth embodiment of the present invention. The light guide plate 560 has a structure similar to that of the light guide plate 460. However, two connecting corners 567, 568 are provided at two adjacent corners of the light guide plate 560. Each connecting corner 567, 568 is located between two corresponding adjacent flanges 566. An optical film (not shown) that is received in the recessed 565 includes two oblique cutout portions at two corners thereof respectively. The cutout portions match with the connecting corners 567, 568, of the light guide plate 560.

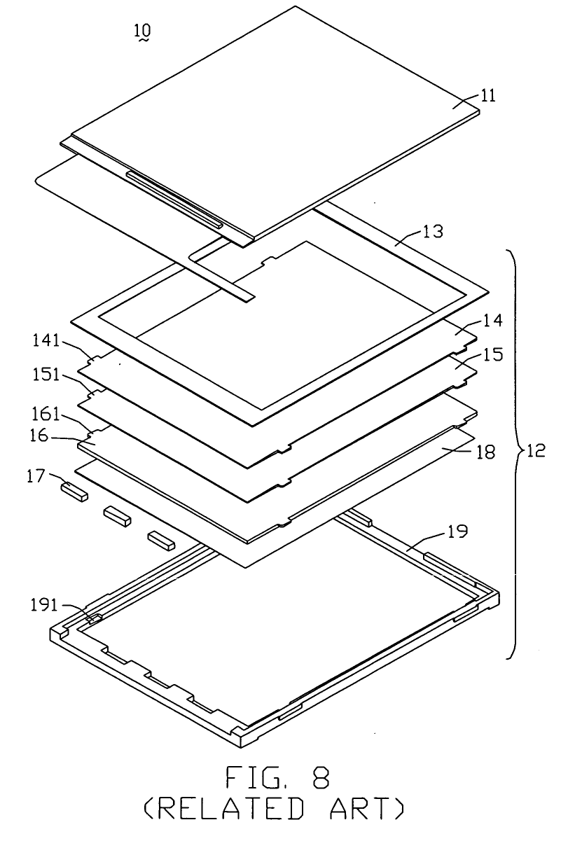

Referring to FIG. 7, this is a schematic, isometric view of a light guide plate according to a sixth embodiment of the present invention. The light guide plate 660 has a structure similar to that of the light guide plate 160. However, the light output surface 661 includes a recessed 665 surrounded by only three flanges 666, which are joined end-to-end to cooperatively form a three-sided U-shaped structure. Thus an opening 667 is defined at a side of the light guide plate 660 between distal ends of two endmost of the flanges 666. An optical film (not shown) may be inserted into the recessed 665 via the opening 667. This configuration can improve the efficiency of assembly of an associated liquid crystal display.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light guide plate comprising a light output surface, the light output surface defining a recessed for receiving at least one optical film.

2. The light guide plate as claimed in claim 1, wherein the light output surface comprises a plurality of flanges surrounding the recessed.

3. The light guide plate as claimed in claim 1, wherein the light output surface comprises four flanges, which are joined end-to-end to cooperatively form a four-sided closed structure surrounding the recessed.

4. The light guide plate as claimed in claim 3, wherein one of the flanges defines a notch adjacent to the recessed.

5. The light guide plate as claimed in claim 3, wherein two opposite flanges define a notch respectively, the notches diagonally opposite each other, and are adjacent to the recessed.

6. The light guide plate as claimed in claim 5, wherein the two notches have different sizes from each other.

7. The light guide plate as claimed in claim 3, further comprising a connecting corner provided between two adjacent flanges.

8. The light guide plate as claimed in claim 3, further comprising two connecting corners provided at two adjacent corners of the light guide plate.

9. The light guide plate as claimed in claim 1, wherein the light output surface comprises three flanges, which are joined end-to-end to cooperatively form a three-sided U-shaped structure surrounding the recessed, and an opening is defined at a side of the light guide plate.

10. A backlight module, comprising:
at least one optical film;
a light guide plate having a light output surface, the light output surface defining a recessed receiving the at least one optical film;
a light source disposed adjacent to a side of the light guide plate; and
a frame containing the light source and the light guide plate.

11. The backlight module as claimed in claim 10, wherein the light output surface comprises a plurality of flanges surrounding the recessed.

12. The backlight module as claimed in claim 10, wherein the light output surface comprises four flanges, which are joined end-to-end to cooperatively form a four-sided closed structure surrounding the recessed.

13. The backlight module as claimed in claim 12, wherein one of the flanges defines a notch adjacent to the recessed.

14. The backlight module as claimed in claim 12, wherein two opposite flanges define a notch respectively, the notches diagonally opposite each other, and are adjacent to the recessed.

15. The backlight module as claimed in claim 14, wherein the two notches have different sizes from each other.

16. The backlight module as claimed in claim 12, further comprising a connecting corner provided between two adjacent flanges.

17. The backlight module as claimed in claim 12, further comprising two connecting corners provided at two adjacent corners of the light guide plate.

18. The backlight module as claimed in claim 10, wherein the light output surface comprises three flanges, which are joined end-to-end to cooperatively form a three-sided U-shaped structure surrounding the recessed, and an opening is defined at a side of the light guide plate.

19. A backlight module, comprising:
one optical film forming a protrusion on one edge thereof;
a light guide plate having a light output surface defining a notch on one edge region; wherein
the optical film is seated upon the light output surface with the protrusion received in the notch.
